(19) United States
(12) Patent Application Publication
(10) Pub. No.: US 2005/0069376 A1
(43) Pub. Date: Mar. 31, 2005

(54) Compound coupling

(75) Inventor: Douglass L. Blanding, Rochester, NY (US)

Correspondence Address: Milton S. Sales;Patent Legal Staff, Eastman Kodak Company, 343 State Street, Rochester, NY, 14650-2201, US

(73) Assignee: Eastman Kodak Company

(21) Appl. No.: 10/670,439

(22) Filed: Sep. 25, 2003

(51) Int. Cl. F16B 1/00

(52) U.S. Cl. 403/30

(57) ABSTRACT

A compound coupling for mounting a component (60) having a first coefficient of thermal expansion (CTE) to a base (62) having a second CTE, the compound coupling comprising a first flexure coupling (40), a second flexure coupling (40), and a third flexure coupling (40), each flexure coupling (40) extends from the base (62) to the component (60) and attached to the base (62) at a first and a second mount point (66, 68) associated with that flexure coupling (40). Each flexure coupling (40) is also attached to the component (60) at an associated component mount point (64). Each flexure coupling (40) has a flexure CTE substantially equal to the second CTE of base (62).

### FIELD OF THE INVENTION

The present invention generally relates to an apparatus and method for mounting a component in an apparatus and more particularly relates to a mounting apparatus and method for positioning of components in an optical subsystem that is subject to thermal excursions between idle and operating temperatures.

### BACKGROUND OF THE INVENTION

In electronic imaging devices, separate color paths are typically used for directing monochromatic light to image sensing or to image forming components. In the illumination path for such devices, a color separating prism is often used to provide, from a single high-intensity white light source, monochromatic red (R), green (G), and blue (B) light along separate paths. Types of color-separating prism well known in the electronic imaging arts include X-cubes or X-prisms and related dichroic optical elements, such as those disclosed in U.S. Pat. Nos. 5,098,183 (Sonehara) and 6,019,474 (Doany et al.) A Philips prism, such as that disclosed in U.S. Pat. No. 3,202,039 (DeLang et al.) may also be used in color separator applications.

Color separator prisms are just one exemplary type of optical device that must be precisely positioned within an optical subsystem in order to provide accurate imaging. Unless some type of positional compensation is provided, temperature changes that occur during equipment warm-up or during extended operation can cause shifting of a color separator prism, or of similar components, with respect to an intended optical path. In apparatus using a high-energy illumination source, for example, heat generated from the illumination source and from other equipment sources can cause ambient and chassis temperatures to change over time. Due to mechanical hysteresis effects, transitions in temperature can cause undesirable repositioning of mounted components during temperature transitions or excursions. Because of this, even where careful warm-up procedures are followed for achieving suitable operating temperature for an optical subsystem, some shifting or slippage of a prism or lens mount can occur. This results in undesirable shifting of the paths of modulated light, possibly requiring constant recalibration and readjustment in order to maintain pixel-to-pixel registration between color paths.

Referring to FIG. 1, there is shown a simplified block diagram of optical paths within a conventional telecine apparatus 10. Telecine apparatus 10 is used to obtain a digital red, green, blue (RGB) image from each frame 26 of a motion picture film 24. A polychromatic light source 12, such as a high-intensity Xenon lamp, directs light through frame 26 and through a lens 22 to direct the image-bearing light to a color separator prism 20, represented as a Philips prism in FIG. 1. Color separator prism 20 separates RGB color components of frame 26 and directs modulated light to the appropriate red sensor 30r over red optical axis Oᵣ, to green sensor 30g over green optical axis O_{g}, or to blue sensor 30b over blue optical axis O_{b}, for obtaining the digital image. In a typical telecine apparatus 10, red, green, and blue sensors 30r, 30g, and 30b are linear devices, each obtaining a single line of the frame 26 image at a time. Film 24 is moved in a direction D across the optical path, enabling a full scan of each frame 26. It must be emphasized that the block diagram of FIG. 1 is highly simplified; a number of other types of supporting optical components may be used for further conditioning illumination or modulated light within telecine apparatus 10, as is well known to those familiar with telecine apparatus design.

As can be readily appreciated from the block diagram of FIG. 1, light source 12 must generate a substantial amount of light, since the light used for image sensing is split into three separate optical paths. Light source 12, therefore, may generate a significant amount of heat during operation of telecine apparatus 10. It can be appreciated that there is a temperature excursion during the interval that begins when telecine apparatus 10 is switched from an initial off-state and ends when a suitable, stable operating temperature is reached. Another significant temperature excursion occurs as telecine apparatus 10 equipment cools from operation to an idle state. During such temperature excursions, ambient temperatures, component temperatures, and temperatures of mounting structures and surrounding supporting structures change at different rates, depending on factors such as materials used, cooling methods, and open space provided around components. With reference to the optical arrangement of FIG. 1, temperature excusions place demands on the external mounting arrangement for color separator prism 20. In particular, mechanical drift and stresses from external mounting components, experienced during temperature transitions, must be minimized to prevent unwanted movement of color separator prism 20 with respect to the color paths of red optical axis Oᵣ, blue optical axis O_{b}, and green optical axis O^{g}.

Conventional prism mounting techniques for color separator prisms and other heat sensitive prism applications are characterized by mechanical complexity, over-constraint, crowding, and need for precision adjustment and liberal allowed tolerances for heat effects. For example:
U.S. Pat. No. 6,181,490 (Wun et al.) discloses an adjustable optical frame used for a prism in an optical combiner application in which a prism is enclosed within a complex sheet metal frame that provides multiple constraints on prism movement and expansion and has numerous adjustments;
U.S. Pat. No. 3,848,973 (Merz et al.) discloses a prism holder for use in a light deflection system, in which a compression mounting assembly is employed;
U.S. Pat. No. 5,749,641 (Brice et al.) discloses a color combiner or separator prism enclosed on five sides within a complex frame structure having multiple sections, with some frame sections used to support mounting of other optical components;
U.S. Pat. No. 6,141,150 (Ushiyama et al.) discloses a dichroic prism mounting method using oversized components, requiring complex alignment procedures and presenting demanding adhesive requirements; and
U.S. Pat. No. 6,010,221 (Maki et al.) discloses a prism mount for a projection apparatus, using a diecast holding member that surrounds the prism in an arrangement that would not be optimal for applications undergoing thermal transitions and may over-constrain the prism.

As a rule of thumb, the literature for prism mounting generally recommends using some type of kinematic configuration, such as mechanical compression, as is discussed in Handbook of Optical Engineering, Anees Ahmad, Editor, CRC Press, New York, N.Y., 1997, pp. 202-210. However, attempts to provide suitable prism mounting using spring forces, frames, or other kinematic mechanical constraints have proved inadequate to the task of providing a stable mount for many types of color separator prism 20 in telecine apparatus 10, primarily due to sliding friction at kinematic contact points, caused by thermal expansion of dissimilar materials at different rates. Because color separator prism 20 is fabricated as an assembly of glued prism components, mounting schemes should minimize, equalize, or eliminate mechanical stress on glued seams where possible. Unwanted stress birefringence occurring due to constraining forces applied against any prism surface, should also be minimized.

Mechanical hysteresis resulting from temperature transitions is a recognized problem with the optics path of conventional telecine apparatus 10 as shown in FIG. 1. With conventional types of telecine apparatus 10, for example, suitable warm-up time must be provided in order to achieve the proper operating temperature. As internal temperatures rise toward operating temperature, some shifting of optical components invariably occurs, which can have adverse effects on image registration. The crux of the problem is that once the proper operating temperature is reached, optical components may not return to a precise position, due to some degree of temperature-related mechanical hysteresis. Instead, sliding friction may result in an undesirable repositioning of color separator prism 20 relative to red optical axis Oᵣ, blue optical axis O_{b}, and green optical axis O_{g}. This sliding friction can occur even when kinematic mounting techniques are employed. As a result, pixel-to-pixel registration between the color optical axes can be shifted, causing undesirable color fringing in printed frames 26. Conventional mounting and fastening techniques for color separator prism 20 have yielded poor results due to temperature-related mechanical hysteresis with telecine apparatus 10.

Flexure mounting is known for use in applications where various types of optical components must be mounted in relatively precise positions, yet need some degree of freedom. Conventional techniques and general principles for flexure mounting of mirrors and prisms are given by Paul R. Yoder, Jr. in Opto-Mechanical Systems Design, Marcel Dekker, Inc., New York, 1986, pp. 205-209. Some examples of conventional flexure coupling schemes for optical components are disclosed in U.S. Pat. Nos. 5,801,891 (Lloyd); 4,850,674 (Hasselskog); and 5,550,669 (Patel). Using this type of mount, each flexure blade or strut exhibits stiffness with respect to forces applied along its length, but allows bending in response to forces applied orthogonal to its length. This allows some degree of freedom for movement in some directions, while restricting movement in the length direction.

While flexure mounts have proven utility for maintaining positional accuracy to prevent unwanted shifting of components in many types of applications, adaptation of this type of mounting to thermal excursion applications introduces additional requirements. For example, in considering telecine apparatus 10 of FIG. 1, it is necessary that color separator prism 20 have precisely the same position following a temperature excursion to operating temperature. That is, mechanical hysteresis effects must be eliminated with respect to operating temperature. Ideally, at any given temperature Tₙ during its excursion to or from operating temperature, color separator prism 20 should have the same relative position Pₙ. It can be readily appreciated that achieving this type of temperature-dependent positional accuracy would be particularly beneficial. Among the challenges that complicate such a solution is the likelihood that color separator prism 20 and its associated mounting hardware exhibit a coefficient of thermal expansion (CTE) that is different from the CTE of supporting chassis components.

Thus, it can be seen that there is a need for a mounting apparatus and method for coupling a prism or other optical component to a supporting structure that maintains positional accuracy of the prism or other optical component as a function of temperature conditions.

### SUMMARY OF THE INVENTION

It is an object of the present invention to provide a compound coupling for mounting a component having a first coefficient of thermal expansion (CTE) to a support structure having a second CTE, the compound coupling comprising a first flexure coupling, a second flexure coupling, and a third flexure coupling, each flexure coupling extends from the support structure to the component and each of the flexure coupling:
(a) is attached to the support structure at a first and a second mount point;
(b) is attached to the component at a component mount point; and
(c) has a flexure CTE substantially equal to the second CTE.

It is a feature of the present invention that it provides a three-point suspension mounting using a V-flexure arrangement suitably arranged for each point.

It is an advantage of the present invention that it presents minimal obstruction to air flow for cooling the component.

It is an advantage of the present invention that it provides a mechanical mounting solution that is mechanically simple and robust.

It is a further advantage of the present invention that it controls component position as a function of temperature. Using the compound coupling solution of the present invention, a component is restored to a precise position according to desired temperature conditions.

It is yet a further advantage of the present invention that it provides a relatively low-cost solution for suspension mounting of a component, such as an optical component.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a schematic block diagram showing the arrangement of optical components in a telecine apparatus of the present invention;

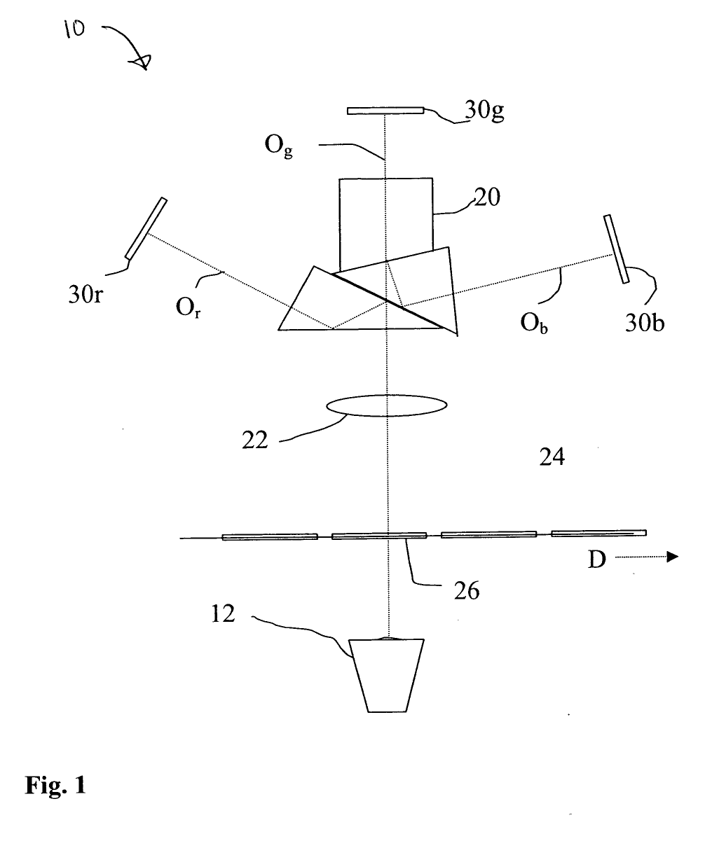

FIG. 2a is a simplified perspective view showing the conceptual arrangement of a flexure coupling according to the present invention;

FIG. 2b is a simplified perspective view showing the conceptual arrangement of an alternate embodiment of a flexure coupling according to the present invention;

FIG. 2c is a simplified perspective view showing the conceptual arrangement of another alternate embodiment of flexure couplings according to the present invention;

FIGS. 3a, 3b, and 3c are side views showing the response of flexures of the present invention to thermal expansion for dissimilar materials;

FIG. 4 is a perspective view showing a prism mount according to the present invention;

FIG. 5 is a plane view of a prism mount according to the present invention;

FIG. 6 is a side view of a prism mount according to the present invention; and

FIG. 7 is a perspective view, from the side, of a prism mount according to the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

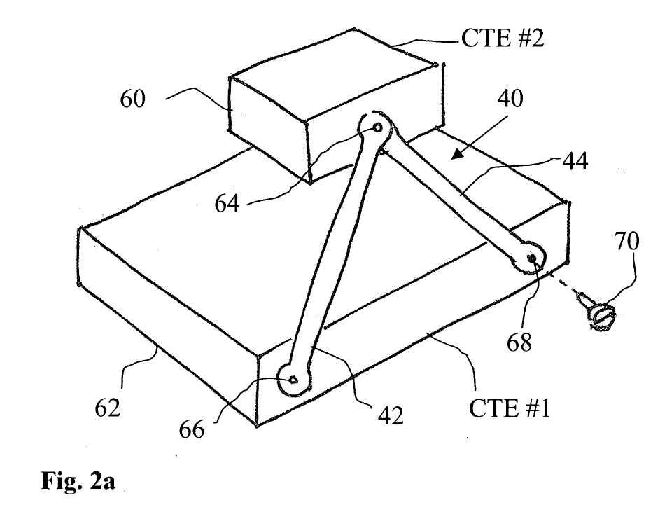

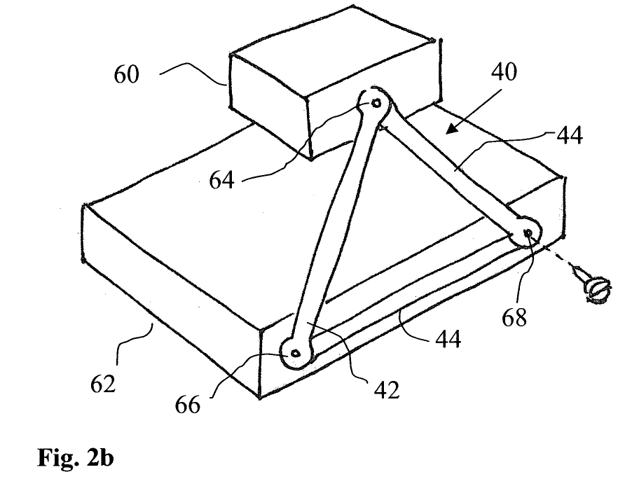

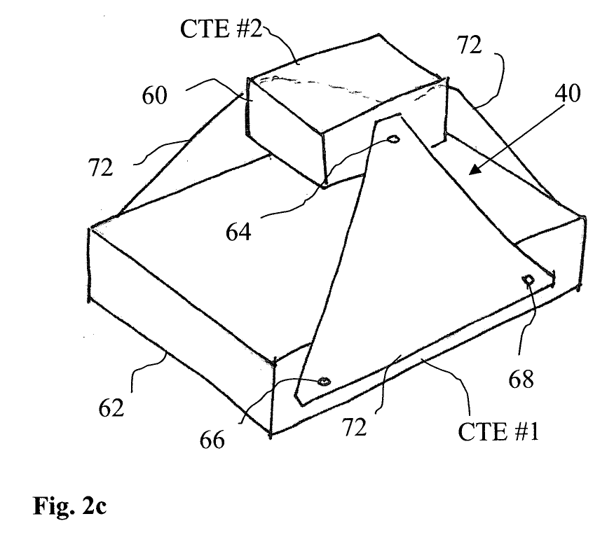

Referring to FIG. 2a, there is shown the basic arrangement of components served by a flexure coupling 40 of the present invention. For simplicity, only one flexure coupling 40 is shown in FIG. 2a. Flexure coupling 40 is part of the compound coupling used to mount a component 60 to a base 62 or other support structure, such as a chassis plate, for example. In a preferred embodiment, flexure coupling 40 comprises a pair of struts 42, 44 that extend from mount points 66 and 68 on base 62 to a mount point 64 on component 60. A fastener 70, such as a screw or bolt, is typically used to attach struts 42, 44 to mount points 64, 66, 68. In the configuration of FIG. 2a, flexure coupling 40 thereby forms a V-mount.

Base 62 and component 60 have different CTE values, as shown in FIG. 2a. In the configuration of FIG. 2a, struts 42 and 44 have substantially the same CTE as base 62 (that is, CTE #1). With this arrangement, the open end of the V-mount (that is, the side at which struts 42 and 44 have separate mount points 66, 68 is at base 62.) Common mount point 64 is at the vertex of the V-mount. It can be seen that expansion of base 62 when heated also affects the positions of mount points 66 and 68. Flexure coupling 40 allows this physical expansion and allows controlled movement of component 60. During a temperature excursion, the combined action of three flexure couplings 40, as is described herein below, restores component 60 to a position that is a function of temperature. At any temperature Tₙ within the temperature excursion range, component 60 is disposed at a specific corresponding position Pₙ. This means that repeatable positioning can be obtained at an operating temperature, so that, following any upward or downward excursion, once an operating temperature is reached, component 60 is restored to the same position held at the last time that same operating temperature was reached.

Referring to the alternate embodiment of FIG. 2b, there may be conditions under which an additional strut 44 is fitted between mounting points 66 and 68, such as for improved stability.

Referring to the alternate embodiment of FIG. 2c, another alternate embodiment is shown, wherein a single sheet flexure 72 is employed as flexure coupling 40. With this arrangement, sheet flexure 72 also has a CTE that is substantially equal to the CTE of base 62, using the same principle described with respect to FIG. 2a.

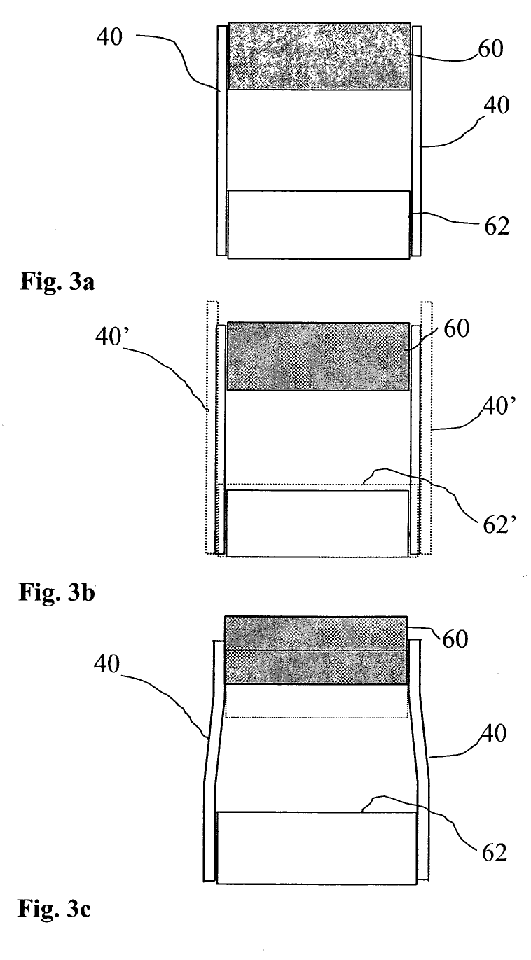

Referring to FIGS. 3a, 3b, and 3c, there is shown, in exaggerated form, how flexure coupling 40 of the present invention operates to compensate for differences in CTE between component 60 and base 62 during a temperature excursion. Here, flexure coupling 40 has the same CTE as base 62, while component 60 has a relatively much lower CTE. FIG. 3a shows flexure couplings 40 supporting component 60 from base 62 at a reference temperature. FIG. 3b shows what would happen at an elevated temperature, if there were no attachment of flexures 40′ (shown in phantom) to a base 62′ (shown in phantom) at this temperature. Due to thermal effects, there is noticeable expansion of flexures 40′ and base 62′ as shown; however, component 60, with a much lower CTE, exhibits almost no expansion. Base 62′ grows larger in each dimension, as do flexures 40′. The reference temperature state in FIG. 3 a is for comparison with the response to elevated temperature shown in FIG. 3c. In FIG. 3c, there is shown how flexures 40, when attached between base 62 and component 60, operate to eliminate hysteresis effects, by bending in a widthwise direction. This ability to bend gives the arrangement of flexure couplings 40 an advantage over other types of coupling methods, particularly over methods that, due to temperature excursion, allow sliding friction and, therefore, allow consequent shifting of position.

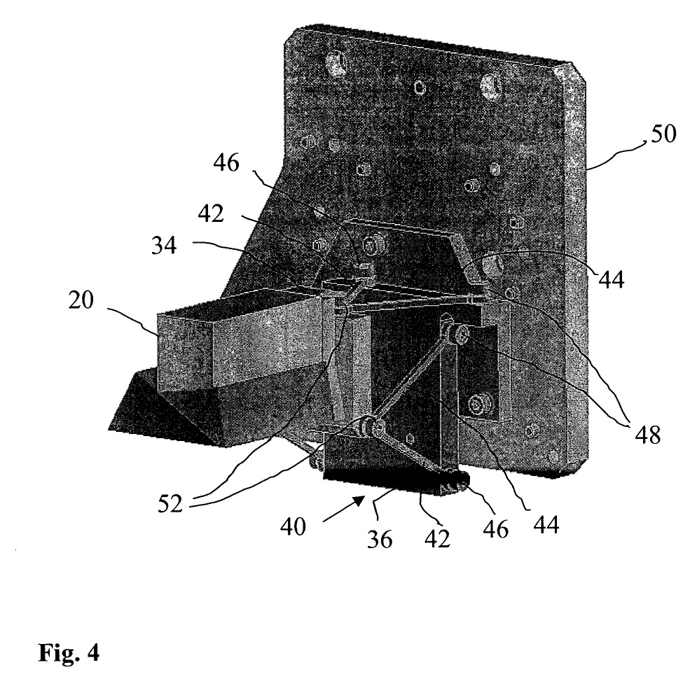

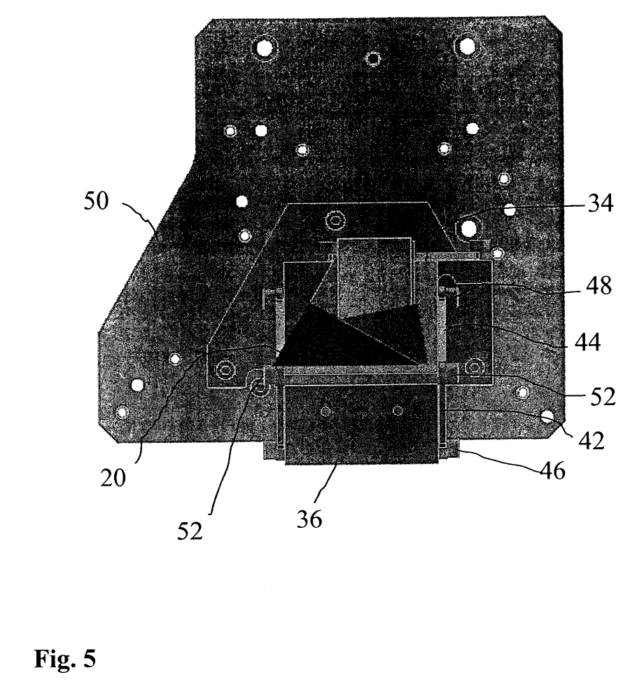

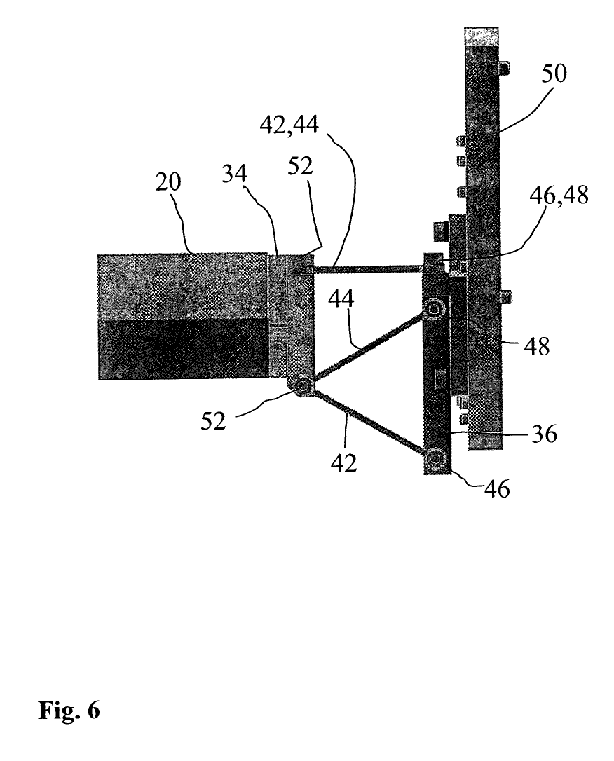

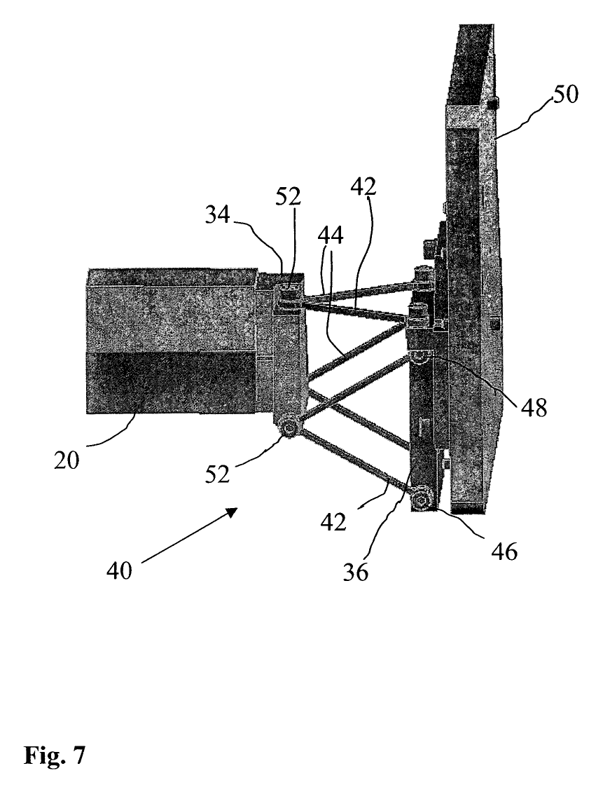

Referring to FIGS. 4-7, there is shown a compound coupling using three flexure couplings 40 for color separator prism 20, suitable for use within telecine apparatus 10. A surface of color separator prism 20 is mounted to a prism mounting plate 34. In one embodiment, prism mounting plate 34 is a metal plate glued to a surface of color separator prism 20. The material used for prism mounting plate 34 is selected to have a coefficient of thermal expansion (CTE) compatible with that of the glass components of color separator prism 20, a Philips prism as shown in FIG. 4.

Prism mounting plate 34 has three strut junction mounting points 52, two of which are visible from the perspective view of FIG. 4. Extending from each strut junction mounting point 52 is a pair of struts 42, 44, which provide a V-shaped flexure coupling 40 between prism mounting plate 34 and a chassis mounting plate 36 that is securely mounted onto a chassis 50. Strut 44 extends from strut junction mounting point 52 to a strut mounting point 48. Strut 42 extends from strut junction mounting point 52 to a strut mounting point 46. Using this arrangement for strut junction mounting points 52, three separate V-shaped flexure couplings are provided between prism mounting plate 34 and chassis mounting plate 36. As was described with reference to FIGS. 2a and 3a-3c, the CTE of struts 42, 44 is equal to, or very nearly equal to, the CTE of chassis mounting plate 36.

By using the V-flexure structures of the present invention as flexure coupling 40, and using the same, or closely matched, materials for struts 42, 44 and chassis mounting plate 36, hysteresis effects of thermal expansion are minimized. Struts 42 and 44 are rigid along their lengths, but can bend under stress, as is shown in FIG. 3c, such as under conditions of thermal expansion of prism mounting plate 34 or of chassis mounting plate 36. This flexibility allows each flexure coupling 40 to restore color separator prism 20 to proper position following temperature transition, such as following power-up, for example. No mechanical slippage due to sliding friction is permitted by flexure coupling 40. By using three separate flexure couplings 40 as this compound coupling solution, the present invention constrains movement of color separator prism 20 in any direction, without applying over-constraint. Depending on the type of application, two flexure couplings 40 could be used as part of a compound coupling solution, but without the inherent 3-dimensional constraint and precise maintenance of position with respect to temperature of a solution using three flexure couplings 40.

Using either V-flexures (as in FIGS. 2a, 2b, and 4-7) or a single sheet flexure 72 (as in FIG. 2c), there are three mount points for each flexure coupling 40. Two mount points are used on the element that matches the CTE of flexure coupling 40 components. For the configurations in FIGS. 2a, 2b, 2c, 3a, 3b, 3c, and 4-7, the CTE of flexure coupling 40 matches that of chassis mounting plate 36 or base 62. However, it must be observed that there could be alternate embodiments where it is advantageous to have the CTE of flexure coupling 40 match that of component 60 or prism mounting plate 34. For such an embodiment, the V-flexure orientation would then be reversed, with two mount points on component 60 and a single mount point on chassis mounting plate 36 or base 62.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. The present invention could be applied for positioning an image sensor, such as a CCD sensor, for example. It must be observed that the apparatus and methods of the present invention could be applied for prisms and optical components in many types of applications, including color separation and color combining, as well as for components not having an optical function. As an alternative to mechanical fasteners, an adhesive may be suitable for securing flexure strut attachment at one or more mounting points.

The apparatus and methods of the present invention are particularly useful in applications where it is necessary to couple a component with a base support where these two devices have different CTE values.

Thus, what is provided is an apparatus and method for flexure coupling of an optical component that is resilient to temperature excursions.

### PARTS LIST

10 telecine apparatus
12 light source
20 color separator prism
22 lens
24 film
26 frame
30r sensor, red
30g sensor, green
30b sensor, blue
34 prism mounting plate
36 chassis mounting plate
40 flexure coupling
40′ flexures
42 strut
44 strut
46 strut mounting point
48 strut mounting point
50 chassis
52 strut junction mounting points
60 component
62 base
62′ base
64 mount point
66 mount point
68 mount point
70 fastener
72 sheet flexure

1. A compound coupling for mounting a component having a first coefficient of thermal expansion (CTE) to a support structure having a second CTE, the compound coupling comprising a first flexure coupling, a second flexure coupling, and a third flexure coupling, wherein each of said flexure coupling extends from said support structure to said component and wherein each of said flexure coupling:
(a) is attached to said support structure at a first and a second mount point;
(b) is attached to said component at a component mount point; and
(c) has a flexure CTE substantially equal to said second CTE.

2. A compound coupling according to claim 1 wherein said component comprises a prism.

3. A compound coupling according to claim 2 wherein said prism is selected from a group consisting of a Philips prism and an X-prism.

4. A compound coupling according to claim 1 wherein said component comprises a lens.

5. A compound coupling according to claim 1 wherein said component comprises a detector.

6. A compound coupling according to claim 5 wherein said detector is a charge-coupled device.

7. A compound coupling according to claim 1 wherein a fastener provides attachment at said component mount points.

8. A compound coupling according to claim 1 wherein an adhesive provides attachment at said component mount points.

9. A compound coupling according to claim 1 wherein at least one flexure coupling comprises a pair of struts.

10. A compound coupling according to claim 1 wherein at least one flexure coupling is a single sheet flexure.

11. A compound coupling according to claim 1 such that a triangle is defined by said component mount point for a first flexure coupling, said component mount point for a second flexure coupling, and said component mount point for a third flexure coupling.

12. A compound coupling according to claim 11 wherein said triangle is equilateral.

13. A compound coupling according to claim 1 wherein said flexure coupling are selected from a group consisting of aluminum and stainless steel.

14. A compound coupling according to claim 1 wherein one of said flexure couplings comprises:
(a) a first strut extending from said first mount point to said component mount point;
(b) a second strut extending from said second mount point to said component mount point; and
(c) a third strut extending from said first mount point to said second mount point.

15. A compound coupling for mounting a component having a first coefficient of thermal expansion (CTE) at a spatial position with respect to a support structure having a second CTE, the compound coupling comprising a first flexure coupling, a second flexure coupling, and a third flexure coupling, each of said flexure coupling extending from said support structure to said component and:
(a) attached to said component at a first and a second component mount point assigned to said flexure coupling;
(b) attached to said support structure at a structure mount point assigned to said flexure coupling; and
each said flexure coupling having a flexure CTE substantially equal to said first CTE.

16. A compound coupling according to claim 15 wherein the component comprises a prism.

17. A compound coupling according to claim 16 wherein said prism is taken from the group consisting of a Philips prism, an X-prism.

18. A compound coupling according to claim 15 wherein the component comprises a lens.

19. A compound coupling according to claim 15 wherein the component comprises a detector.

20. A compound coupling according to claim 19 wherein said detector is a charge-coupled device.

21. A compound coupling according to claim 15 wherein a fastener provides attachment at said structure mount point.

22. A compound coupling according to claim 15 wherein an adhesive provides attachment at said structure mount point.

23. A compound coupling according to claim 15 wherein said first flexure coupling comprises a pair of struts.

24. A compound coupling according to claim 15 wherein said first flexure coupling is a single sheet flexure.

25. A compound coupling according to claim 15 such that a triangle is defined by said structure mount point for said first flexure coupling, said structure mount point for said second flexure coupling, and said structure mount point for said third flexure coupling.

26. A compound coupling according to claim 25 wherein said triangle is equilateral.

27. A compound coupling according to claim 15 wherein said flexure coupling is taken from the group consisting of aluminum and stainless steel.

28. A compound coupling according to claim 15 wherein said first flexure coupling comprises:
(a) a first strut extending from said first component mount point to said structure mount point;
(b) a second strut extending from said second component mount point to said structure mount point; and
(c) a third strut extending from said first component mount point to said second component mount point.

29. A compound coupling for mounting a component having a first coefficient of thermal expansion (CTE) at a spatial position with respect to a support structure having a second CTE, the compound coupling comprising at least a first flexure coupling and a second flexure coupling, each said flexure coupling extending from said support structure to said component and:
(a) attached to said support structure at a first and a second mount point associated with said flexure coupling;
(b) attached to said component at a component mount point associated with said flexure coupling; and
each said flexure coupling having a flexure CTE substantially equal to said second CTE.

30. A method for mounting a component having a first coefficient of thermal expansion (CTE) at a spatial position with respect to a support structure having a second CTE, the method comprising extending, from said support structure to said component a first flexure coupling, a second flexure coupling, and a third flexure coupling, by:
(a) attaching said first flexure coupling between a first and a second mount point on said support structure and a first component mount point on said component;
(b) attaching said second flexure coupling between a third and a fourth mount point on said support structure and a second component mount point on said component;
(c) attaching said third flexure coupling between a fifth and a sixth mount point on said support structure and a third component mount point on said component; and
each said flexure coupling having a flexure CTE substantially equal to said second CTE.

31. A method for mounting a component according to claim 30 wherein the step of attaching said first flexure coupling comprises the step of affixing a fastener.

32. A method for mounting a component according to claim 30 wherein the step of attaching said first flexure coupling comprises the step of applying an adhesive.

33. A method for mounting a component according to claim 30 wherein the step of attaching said first flexure coupling comprises the step of attaching a metal strut between said first mount point on said support structure and said first component mount point on said component.

34. A method for mounting a component having a first coefficient of thermal expansion (CTE) at a spatial position with respect to a support structure having a second CTE, the method comprising extending, from said support structure to said component a first flexure coupling, a second flexure coupling, and a third flexure coupling, by:
(a) attaching said first flexure coupling between a first and a second component mount point on said component and a first structure mount point on said support structure;
(b) attaching said second flexure coupling between a third and a fourth component mount point on said component and a second structure mount point on said support structure;
(c) attaching said third flexure coupling between a fifth and a sixth component mount point on said component and a third structure mount point on said support structure; and
each said flexure coupling having a flexure CTE substantially equal to said first CTE.

35. A method for mounting a flexure coupling between a first element having a first coefficient of thermal expansion (CTE) and a second element having a second CTE comprising:
(a) forming said flexure coupling from a material having said first CTE;
(b) attaching said flexure coupling to a first and a second mount point on said first element; and
(c) attaching said flexure coupling to a third mount point on said second element.

36. A method for mounting a flexure coupling according to claim 35 wherein said second element comprises a prism.

37. A method for mounting a flexure coupling between a first element having a first coefficient of thermal expansion (CTE) and a prism mount having a second CTE comprising:
(a) forming said flexure coupling from a material having said first CTE;
(b) attaching said flexure coupling to a first and a second mount point on said first element; and
(c) attaching said flexure coupling to a third mount point on said prism mount.
